(19) United States
(12) Patent Application Publication
(10) Pub. No.: US 2023/0005080 A1
(43) Pub. Date: Jan. 5, 2023

(54) SOCIAL NETWORK-BASED CONTENT CURATION AND DISCOVERY PLATFORM

(71) Applicant: 367 Partners Corp., Scarsdale, NY (US)

(72) Inventors: Jeffrey Charles Sherwin, Scarsdale, NY (US); Carrie Shaw, Toronto (CA)

(21) Appl. No.: 17/850,476

(22) Filed: Jun. 27, 2022

Related U.S. Application Data
(60) Provisional application No. 63/216,752, filed on Jun. 30, 2021.

(51) Int. Cl. G06Q 50/00

(52) U.S. Cl. CPC G06Q 50/01

(57) ABSTRACT

A social network-based content curation and discovery platform. According to embodiments, methods and systems are described to provide for content recommendation and discovery mechanisms based on content consumed and recommended by a social network associated with a user system. The social network-based content curation and discovery system enables a target user to establish an associated social network of other users including a group of one or more other users representing sources of content recommendations.

### CROSS-REFERENCE TO RELATED APPLICATION

This application claims the benefit of U.S. Provisional Patent Application No. 63/216,752, filed on Jun. 30, 2021, the entirety of which is incorporated herein by reference.

### TECHNICAL FIELD

The disclosure relates generally to a content management platform, and more particularly to a social network-based content curation and discovery platform.

### BACKGROUND

There are several dozens of streaming services for the consumption of content. With the expansion of streaming services and the constant growth of available content (e.g., movies, series, videos, etc.) identifying content of interest to a particular viewer is increasingly challenging. In particular, viewers attempt to identify and find content that is interesting and suited to their respective likings without a universal guide for finding content. In addition, typical content recommendation engines and user interfaces provide recommendations that are ranked based on a geographically-focused popularity (e.g., a top ten in a certain geographic area), surfaced based on algorithmically-generated similarities to other content consumed by a particular user, or content that is being promoted by the service provider (e.g., promoted content such as new releases or a platform's original content). Conventional recommendations, however, lack personalization with respect to word of mouth sources of recommendations.

### BRIEF DESCRIPTION OF THE DRAWINGS

The disclosure will be understood more fully from the detailed description given below and from the accompanying drawings of various embodiments of the disclosure.

FIG. 1 illustrates an example computing architecture including a social network-based content curation system, in accordance with one or more embodiments of the disclosure.

FIG. 2 illustrates an example a social network-based content curation system configured to manage updates of a watchlist associated with a user, in accordance with one or more embodiments of the disclosure.

FIG. 3 illustrates an example a social network-based content curation system configured to manage interactions of a user system with a feed or watchlist, in accordance with one or more embodiments of the disclosure.

FIG. 4 illustrates an example a social network-based content curation system configured to manage, via an on-screen application of a user system, interactions with watchlist associated with a user, in accordance with one or more embodiments of the disclosure.

FIGS. 5-17 illustrate example graphical user interfaces generated by a social network-based content curation system, in accordance with embodiments of the disclosure.

FIG. 18 is a flow diagram of an example method to manage a social-network based content curation processing, in accordance with one or more embodiments of the disclosure.

FIG. 19 illustrates an example machine of a computer system within which a set of instructions, for causing the machine to perform any one or more of the operations discussed herein, can be executed.

### DETAILED DESCRIPTION

Aspects of the present disclosure are directed to a social network-based content curation and discovery platform. According to embodiments, methods and systems are described to provide for content recommendation and discovery mechanisms based on content consumed and recommended by a social network associated with a user system (herein the “target user”). The social network-based content curation and discovery system (herein referred to as the “social network-based content curation system”) provides an integrated platform to enable a target user to establish an associated social network of other users or “friends” and create a personalized network for sharing information relating to one or more content elements (also referred to as “assets”) among the group of users in the respective social network. According to embodiments, a “social network” relates to a set of related users that are grouped or otherwise associated within the social network-based content curation and discovery platform.

According to embodiments, the social network-based content curation system provides graphical user interfaces to interact with the target user to present, collect, retrieve, provision, etc. information relating to consumable content based on information relating to the target user's social network (e.g., asset consumption histories, comments, ratings, posts, etc.). In an embodiment, the social network-based content curation system manages information relating to the content consumption histories of the social network sources associated with the target user.

Embodiments of the disclosure address the above-mentioned problems and other deficiencies with conventional content recommendation systems by providing a social network-based content curation system that enables target users (e.g., an individual searching for content recommendations associated with a social network or group corresponding to the individual) to review and interact with collected data relating to content consumption of other users in the social network.

Advantageously, the social network-based content curation system provides a social content guide configured to consolidate content across multiple different services and provisions content recommendations based on consumption histories of an identified group of other users (i.e., the users within a social network or social network recommendation sources) associated with a user seeking content recommendations. According to embodiments, the social-network-based content curation system uses a cloud-based graph database where actions, activities, etc. (e.g., posts, recommendations, comments, etc.) associated with a user's social network point to (i.e., are linked or associated with) one or more unique records containing consolidated content across multiple different services. Advantageously, the records are used to consolidate the services and enable multiple users to submit a content-related post (e.g., a post about a television show, movie, etc.) and have those posts associated with a single or same content record (e.g., the multiple posts are associated with a same record relating to a particular television show or episode).

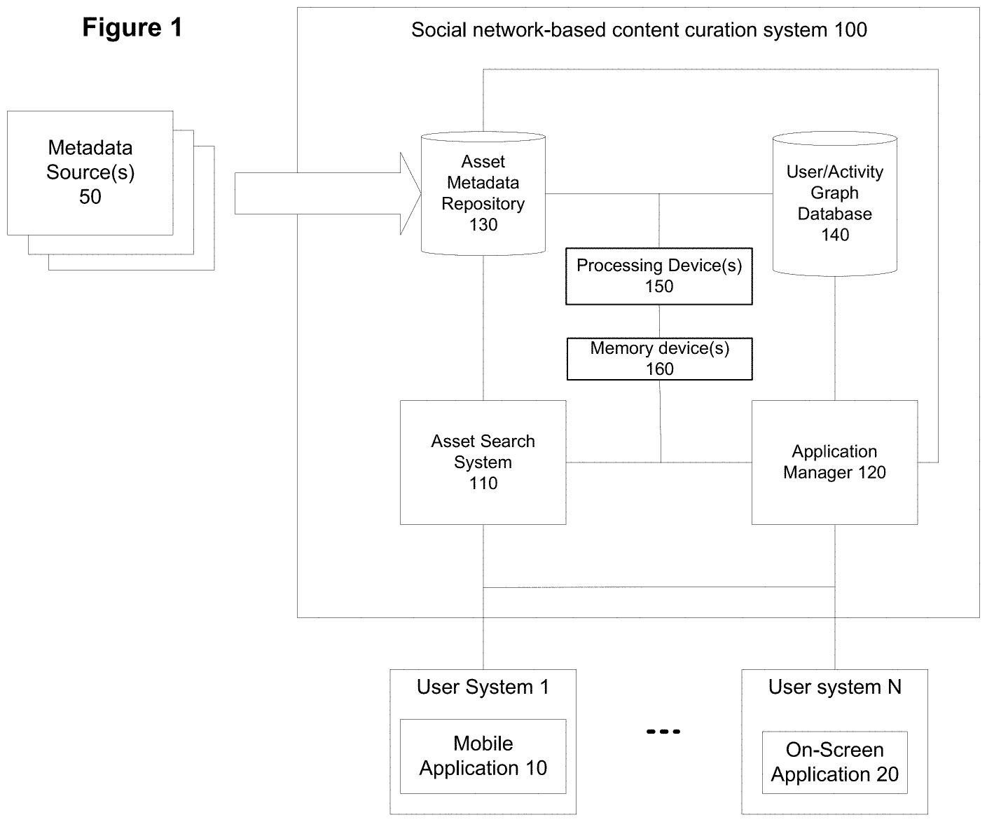

FIG. 1 illustrates an example computing environment including a social network-based content curation system 100 operatively configured to enable the provisioning of social network-based curated content feeds via one or more mobile applications and on-screen applications associated with multiple user devices or user systems (e.g., user system 1 through user system N). According to embodiments, the social network-based content curation system 100 is operatively coupled to the one or more user systems to enable the generating of a social network associated with each user system and managing of the provisioning and sharing of information relating to content (herein referred to as “assets”), such as movies, TV shows, etc.

In one embodiment, the social network-based content curation system 100 enables a user system (herein referred to as a “user” or “target user”) to interact with one or more interfaces configured to manage information relating to one or more assets. In an embodiment, the social network-based content curation system 100 to establish a social network of multiple users to enable the updating and sharing of data relating to the assets among the user systems grouped together within a social network. Advantageously, each user can establish a social network including other users of the social network-based content curation system 100 and generate personalized “watchlists” including asset information and other user-derived information relating to assets that can be shared with other members of a user's social network via the integration platform of the social network-based content curation system 100. In embodiment, the watchlist of a first user can include an ordered listing of information relating to assets, were the information is updated and presented based on actions by one or more users within the social network of the first user. In an embodiment, the watchlist (e.g., a listing of assets) and actions relating to the watchlist (e.g., comments, posts, recommendations, etc.) can be arranged in a “feed” configuration (e.g., in a newsfeed-type arrangement) for display via an interface of a user system. In an embodiment, the user-personalized feed includes an ordered listing of the watchlist and actions and activities of the members of the user's social network. In an embodiment, a cloud-based graph database can be employed to store and retrieve the feed (e.g., the user-personalized newsfeed that is generated for a user) from the watchlist actions and activities.

According to embodiments, the social network-based content curation system 100 can include one or more modules or components configured to perform various functionality, operations, actions, and activities, as described in detail herein. In an embodiment, the social network-based content curation system includes an asset search system 110, an application manager 120, an asset metadata repository 130, and a user/activity graph database 140.

In an embodiment, the social network-based content curation system 100 is operatively coupled (e.g., via a suitable network, application program interface (API), etc.) to one or more metadata sources 50 configured to identify and collect metadata relating to the assets managed by the social network-based content curation system 100. In an embodiment, the one or more metadata sources 50 can include a service (e.g., Gracenote, IMIDB, etc.) configured to provide data relating to the set of assets (e.g., detailed information relating to TV shows, movies, sports, and music) managed by the social network-based content curation system 100.

In an embodiment, the social network-based content curation system 100 includes an asset metadata repository 130 (e.g., a data store such as one or more databases) configured to store the metadata collected from the metadata sources 50. In an embodiment, the asset metadata repository 130 is also configured to store additional user-derived metadata (e.g., popularity metrics associated with the assets, ratings associated with the assets, comments relating to the assets, etc.). In an embodiment, the user-derived metadata can be collected and captured from one or more user systems via an application (e.g., a mobile application 10 or an on-screen application 20) configured to enable the features and functionality of the social network-based content curation system 100. In an embodiment, as described in greater detail below, the user-derived metadata can be collected from the user systems (e.g. user system 1 . . . user system N) via one or more graphical user interfaces (GUIs) of the respective applications (e.g., mobile application or on-screen application).

According to embodiments, the asset metadata repository 130 manages a cloud based graph database configured to process content-related actions and activities (e.g., posts about a television show) and associate those actions with a unique record relating to that particular content element (e.g., a unique television show record). The unique show record can include consolidated content across multiple different services. In an embodiment, the content-related records (e.g., unique records for respective television shows, movies, etc.) consolidate the services and enable multiple users in a social network to submit posts that are linked to a single content record (e.g., a particular television show specific record).

In an embodiment, the mobile application 10 of the social network-based content curation system 100 is a program (e.g., a web-accessible and network-executable program or a downloadable and installable device-executable program) that may be used by a mobile device (e.g., a smartphone, tablet, laptop computer, smartwatch, e-reader, gaming console, etc.) to enable the features and functionality the social network-based content curation system 100 via a mobile user device including searching, displaying and updating watchlists, newsfeeds, social network membership (e.g., friends), asset metadata, user comments, etc., as described in detail herein.

In an embodiment, the on-screen application 10 of the social network-based content curation system 100 is a program executable via a television or display-based device (referred to as a “television device”) such a television, a smart TV, an Internet of Things (IOT) device coupled to a display device, a network-connected device coupled to a display, a streaming device, etc. that enables the features and functionality of the social network-based content curation system 100 via the television device.

In an embodiment, the social network-based content curation system 100 includes a user/activity graph database 140 including an object-based graph database storing data relating to the user systems and users of the social network-based content curation system 100 (herein the “user information”). In an embodiment, the user information includes, but is not limited to, user profile information, watchlist data, user post data (e.g., information associated with a user performing a watchlist-related action (e.g., adding to a watchlist, updating a watchlist, deleting information from a watchlist, etc.), user-generated comments, social network data (e.g., a list of one or more other users in a target user's social network), etc.

The user/activity graph database 140 stores a collection of nodes and relationships between the nodes to store retrievable data relating to each user, social network, and user activity associated with the social network-based content curation system 100. In an embodiment, the user/activity graph database 140 uses graph structures for semantic queries with nodes, edges and properties to represent and store data (e.g., the user data including user profile data, user activity data, watchlists, posts, social networks, etc.). In an embodiment, each user of the social network-based content curation system 100 can be represented in the user/activity graph database 140 by a corresponding graph representing data items and relationships associated with the respective user. The user/activity graph database 140 can include any suitable graph-based data store including, but not limited to the Amazon Neptune graph database.

In an embodiment, the social network-based content curation system 100 includes an asset search system 110 configured to search and update the asset metadata repository 130. In an embodiment, the asset search system 110 enables the searching for and retrieving of information stored in the asset metadata repository 130 based on search queries inputted via an interface of the mobile application 10 and/or the on-screen application 20. In an embodiment, the asset search system 110 can generate search results in response to the search queries for display to a user system. In an embodiment, the asset search system 110 can identify user activities (e.g., user selection or interactions) with respect to the generated search results and use the user activities as feedback for use in subsequent searching and search result generating (e.g., use the user selections to improve subsequent search results). The asset search system 110 can include a configured secure cloud service including, but not limited to, the Amazon Elastic Compute Cloud (EC2) system.

In an embodiment, the system includes an application manager 120 configured to execute one or more microservices to enable features and functionalities of the mobile application 10 and the on-screen application 20. In an embodiment, the application manager 120 can include a collection of microservices to enable activities of the mobile application 10 and the on-screen application 20 including, but not limited to, lookups, posts, comments, etc. The application manager 120 can include an event-driven computing services or set of services that enables the execution of code of the mobile application 10 and the on-screen application, such as, for example, the Amazon Web Services (AWS) Lambda compute service.

In an embodiment, the social network-based content curation system 100 is configured to generate user interfaces of the mobile application 10 and the on-screen application 20, as described herein. In an embodiment, the social network-based content curation system 100 is configured to generate and manage a social network (e.g., a collection of one or more user systems) that are associated with each target user system. In an embodiment, the social network-based content curation system 100 identifies each group of user systems (i.e., the social network of user systems) and manages the posts, comments, recommendations, interactions, inputs, content consumption history, etc. for each user system in the social network. In an embodiment, the social network-based content curation system 100 manages the provisioning of information to members of a social network relating to content consumption for the generating and provisioning of content recommendation-related information.

In an embodiment, the social network-based content curation system 100 is operatively coupled to the one or more metadata sources 50 (e.g., a third party asset metadata generator or content provider system (e.g., Netflix, Amazon Prime Video, Hulu, etc.)) to manage integrations relating to the assets and the provisioning of metadata relating to the assets.

In an embodiment, as shown in FIG. 1, the social network-based content curation system 100 includes one or more processing devices 150 configured to execute instructions stored in one or more memory devices 160 to perform the operations, functions, and features of the various components, services, and modules of the social network-based content curation system 100, as described in greater detail below in connection with the figures and images provided herein.

In an embodiment, the social network-based content curation system 100 can include one or more software modules executable by one or more computer platforms of the social network-based content curation system that are interconnected by one or more networks, which may include the Internet. The software modules may be, for example, a hardware component, circuitry, dedicated logic, programmable logic, microcode, etc., that may be implemented by a processing device executing instructions stored by the memory of the social network-based content curation system.

In an embodiment, the social network-based content curation system 100 is operatively coupled to the one or more user systems (e.g., the target user system and the systems associated with the one or more users of the social network recommendations sources associated with the target user) via a suitable network (not shown), including, for example, the Internet, intranets, extranets, wide area networks (WANs), local area networks (LANs), wired networks, wireless networks, or other suitable networks, etc., or any combination of two or more such networks.

In some embodiments, the social network-based content curation system may include features and functions in the form of a downloadable application or network-accessible web-based service (e.g., a website), such as the mobile application 10 and the on-screen application 20 that may be used by the user systems of the social network-based content curation system 100. In an embodiment, the social network-based content curation system 100 can include one or more modules (e.g., APIs) configured to interact with the user systems (e.g., devices associated with the users of the social network-based content curation system) for carrying out operations and providing content recommendations and related information to the user systems. In an embodiment, the social network-based content curation system may include one or more databases storing all or a portion of the data associated with the social network-based content curation system.

Advantageously, the social network-based content curation system 100 is configured to provide a personalized social network-based content recommendation network to enable the selection of assets to consume and a forum for discussion of the assets based on consumption histories and recommendations associated with a selected group of other users in a target user's social network. This provides for the reduction of noise relating to content recommendation and enables each target user to select the one or more other users as sources of recommendations and filters the vast amount of available content to generate social network-based content recommendations and related information (e.g., discussions, comments, viewing history, engagement indicators (e.g., likes, dislikes), etc.).

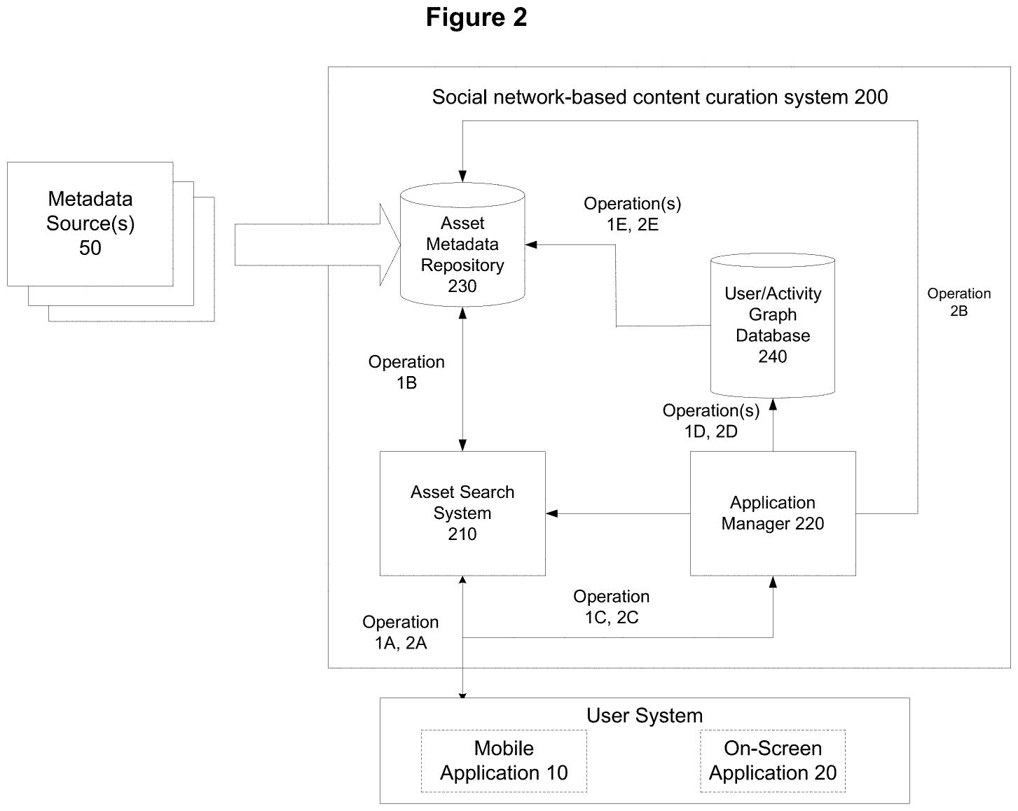

FIG. 2 illustrates an example system 200 configured to perform a set of operations and functions (e.g., a first process flow including operations 1A through 1E or a second process flow including operations 2A through 2E) to enable a user system to add an asset to a corresponding watchlist associated with a user of the user system. In an embodiment, a personalized watchlist corresponding to a user can be generated and stored using the social network-based content curation system 200. In an embodiment, a first set of operations (e.g., 1A to 1E) relating to adding an asset to a watchlist can be initiated by user using an application (e.g., either the mobile application 10 or the on-screen application 20) of a user system to submit a search for an asset, in operation 1A.

In an embodiment, in operation 1B, the asset search system 210 executes a search of the asset metadata repository 230 to identify metadata associated with the asset, based on operation 1A or 1B. In an embodiment, the asset search system 210 generates a search result including a list of assets that can be displayed or otherwise presented to the user system to enable a user selection of a target asset (e.g., a movie, TV show, episode, etc. that the user seeks to add to a corresponding watchlist) from the asset metadata repository 230.

In operation 1c, the user adds the asset to the corresponding watchlist via the application manager 220. In operation 1D, the application manager 220 receives the command to add the asset to the watchlist corresponding to the user system and, in response, executes an “add” or “watchlist add” action to add the asset information in a data graph associated with the user system that is stored in the user/activity graph database 240. In operation 1E, the user/activity graph database 240 executes the watchlist add action to establish and maintain a link or association between the stored watchlist of the user system (e.g., the corresponding data graph) and the identified asset in the asset metadata repository.

In an embodiment, the social network-based content curation system 200 can execute operations 2A through 2E to enable the adding of an asset to a watchlist associated with a user. In operation 2A, the social network-based content curation system 200 can receive an indication corresponding to an observation of an asset in a user's feed (e.g., a streaming feed of activity relating to a user's social network and related consumption and post histories). In an embodiment, a user may interact (e.g., a click, a like, an “add” action, etc.) with an entry in a feed which includes a posting relating to an asset from a member of the user's social network. In operation 2A, the observation relating to the desired asset can be submitted by the user via the mobile application 10 or the on-screen application 20. In operation 2b, the user interacts with the asset from the feed (e.g., views or interacts with the asset details, comments on the asset, selects the asset, etc.)

In operation 2C, the social network-based content curation system 200 identifies, via the application manager 220, a user action corresponding to adding the asset to the user's watchlist. In operation 2D, the application manager 220 receives the command to add the asset to the watchlist corresponding to the user system and, in response, executes an “add” or “watchlist add” action to add the asset information in a data graph associated with the user system that is stored in the user/activity graph database 240. In operation 2E, the user/activity graph database 240 executes the watchlist add action to establish and maintain a link or association between the stored watchlist of the user system (e.g., the corresponding data graph) and the identified asset in the asset metadata repository.

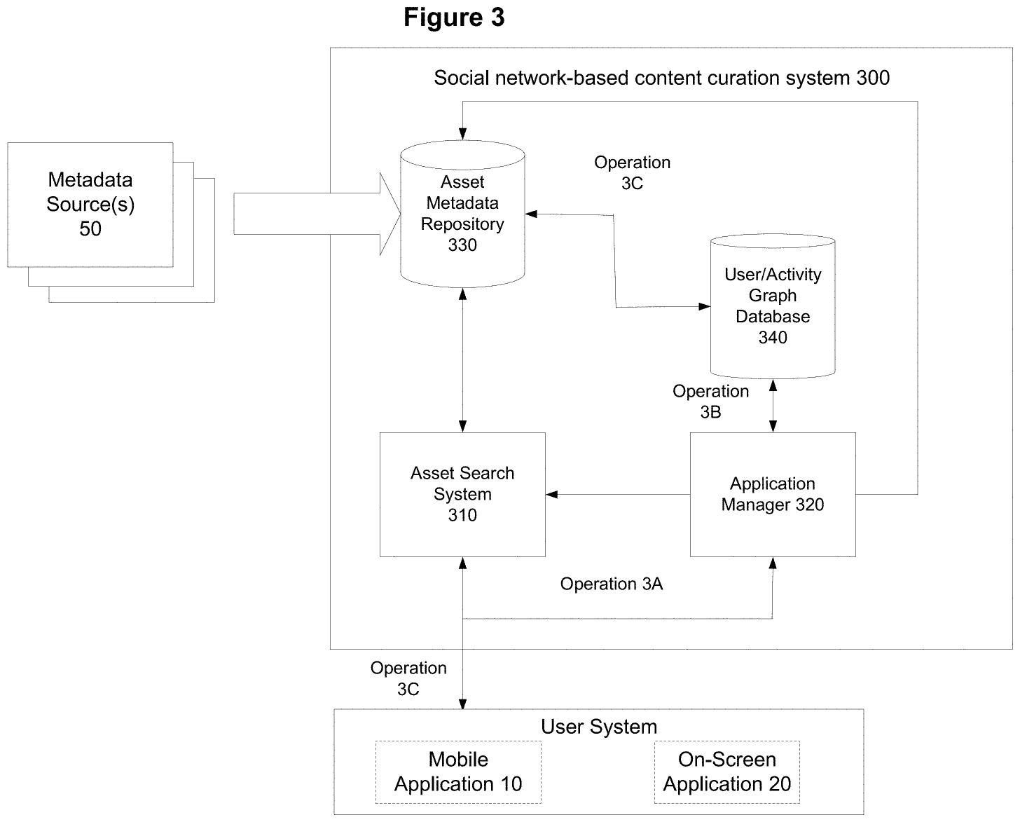

FIG. 3 illustrates an example system 300 configured to perform a set of operations and functions (e.g., a process flow including operations 3A through 3C) to enable a user system to review, check or interface with a feed (e.g., a social network feed or newsfeed) or watchlist, in accordance with one or more embodiments of the present disclosure. In an embodiment, using the mobile application 10 or the on-screen application 20 of the user system, a user can select the feed or watchlist that the user wishes to view. In response to a selection or indication from the user system, the selected watchlist is displayed to enable the user to view the one or more posts or activities of the feed and/or watchlist (e.g., watch activities, comments, interactions, etc.)

In operation 3A, the social network-based content curation system 300 receives a selection of a feed or watchlist from the user system using an application (e.g., either the mobile application 10 or the on-screen application 20). In an embodiment, the selection is received from the user system by the application manager 320. The selected feed or watchlist is requested to enable the user system to view (e.g., via an interface) a set of watchlist activities (e.g., posts) and comments submitted by the user's social network. In an embodiment, the updates from the social network of the user are managed by the social network-based content curation system 300 via the user/activity graph database 440 to allow an updated watchlist to be selected and viewed by the user system.

In operation 3B, the application manager 320 executes a search for information stored in the user/activity graph database 340 corresponding to the selection received from the user system in operation 3A. In an embodiment, the application manager 320 performs the search to identify one or more friends, related activities, and/or comments corresponding to the selected feed or watchlist. In an embodiment, the application manager 320 orders or ranks the search results in accordance with one or more heuristics (e.g., by date, by friend, by rating, etc.) to generate a finalized set of search results configured for return to the user system.

In operation 3C, the user system submits a selection relating to an asset identified in the set of search results returned by the application manager 320. In an embodiment, the selection can include a portion of the search results (e.g., a post of an identified feed, an asset of an identified watchlist, etc.). In response to the selection, information associated with the selected portion is retrieved from the asset metadata repository 330. For example, in operation 3C, using a link established within the user/activity graph corresponding to the user and the selected asset, metadata associated with the selection is identified and returned to the user system. The metadata provided in response to the selection may include, but is not limited to, details relating to the asset, links, descriptions, comments, etc.

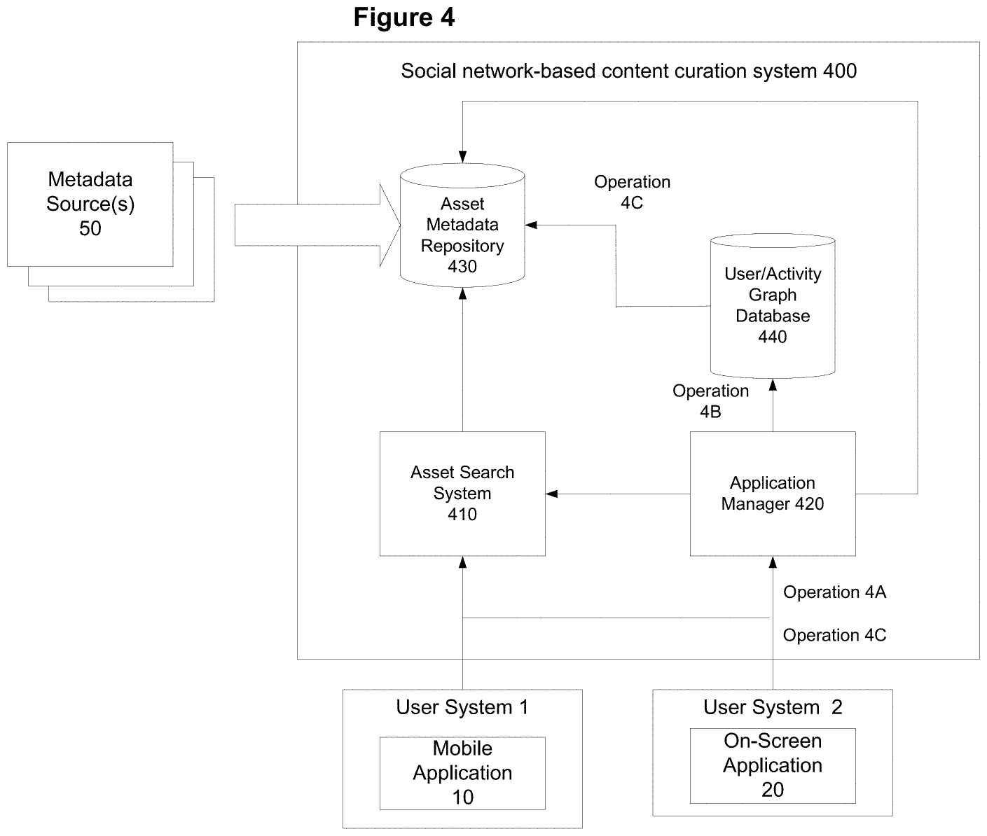

FIG. 4 illustrates an example system 400 configured to perform a set of operations and functions (e.g., a process flow including operations 4A through 4C) to enable a user system (e.g., user system 2 in FIG. 4) to use an on-screen application 20 of a social network-based content curation system 400 to manage, update, and interact with an on-screen watchlist including a listing of identified assets.

In operation 4A, using an interface of the on-screen application 20 of user system 2 (e.g., a smart TV), a user selects a watchlist to view a set of assets stored in association with the user (e.g., a user logged into the on-screen application with corresponding credentials). In an embodiment, the selection of the watchlist can be initiated by the user by performing a search via an interface of the on-screen application 20 or by logging into the on-screen application 20 (e.g., to initiate the retrieval of an updated version of the user's own watchlist). In an embodiment, the watchlist corresponding to the user can be updated based on inputs and interactions occurring via the mobile application 10 of user system 1. In this regard, the user can use the mobile application of user system 1 (e.g., a mobile phone) to update the user's watchlist, such that the updated watchlist is presented to the same user via the on-screen application 20 via user system 2 (e.g., the user's smart TV). In an embodiment, the updated watchlist can include metadata relating to assets based on friends' postings or comments (e.g., a comment from a friend with the user's social network). For example, an asset may be listed in the user's watchlist with a visual indication (e.g., a name, image, etc.) of one or more friends within the user's social network that have interacted with the asset (e.g., commented on the asset, consumed the asset, posted about the asset, rated the asset, etc.). In an embodiment, the user's watchlist can be identified and generated by the application manager 420 for display via one or more interfaces of the on-screen application 20.

In operation 4B, the application manager 420 executes a search for information stored in the user/activity graph database 440 corresponding to the selection received from the user system in operation 4A. In an embodiment, the application manager 420 performs the search to identify one or more friends, related activities, and/or comments corresponding to the selected feed or watchlist. In an embodiment, the application manager 420 orders or ranks the search results in accordance with one or more heuristics (e.g., by date, by friend, by rating, etc.) to generate a finalized set of search results configured for return to the user system.

In operation 4C, the user system submits a selection relating to an asset identified in the set of search results returned by the application manager 420. In an embodiment, the selection can include a portion of the search results (e.g., a post of an identified feed, an asset of an identified watchlist, etc.). In response to the selection, information associated with the selected portion is retrieved from the asset metadata repository 430. For example, in operation 4C, using a link established within the user/activity graph corresponding to the user and the selected asset, metadata associated with the selection is identified and returned to the user system 2. The metadata provided in response to the selection may include, but is not limited to, details relating to the asset, links, descriptions, comments, etc. In an embodiment, the user may interact with the watchlist via an interface of the on-screen application 20 to select an asset (e.g., a TV show or movie) to view additional details, links, or associated metadata. In an embodiment, the user may input an action, via the on-screen application 20, to initiate viewing the asset from one or more associated content provider services (e.g., Netflix, Hulu, Disney Plus, etc.). In an embodiment, a link may be established between the on-screen application 20 and an associated content provider service to enable viewing of the asset. In an embodiment, the user can interact with asset via the on-screen application 20 to initiate the launch or execution of the corresponding content provider service and the loading of the selected asset via the content provider service.

According to embodiments, as described herein, the social network-based content curation system (e.g., systems 100, 200, 300 and 400 of FIGS. 1, 2, 3, and 4) is configured to executed various operations and functions to enable the features and corresponding interfaces, examples of which are described herein.

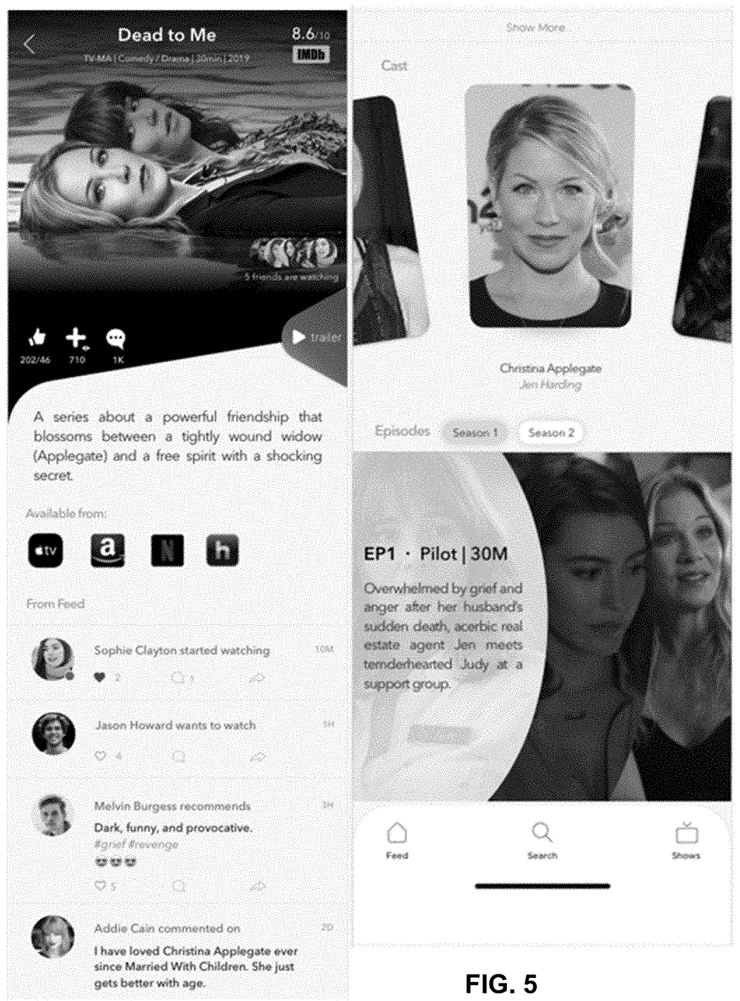

FIG. 5 illustrates an example “Show Detail” interface generated by the social network-based content curation system that displays metadata for given content (e.g., a particular show), and offers functionality to a) add the show to the user's watchlist and b) interact with members of the user's social network (also referred to as the user's “friends”) who are engaged in the same show. In an embodiment, the interface includes, metadata, watchlist, and social interaction functionality.

Example show metadata can include, but is not limited to, the information identified in the following table:

Show Metadata

| Element | |
|---|---|
| on screen | Column Name in data file |
| 1 | show_title |
| 2 | show_maturity_rating \| show_genre (ellipsize after x chars) \| |
| | show_length \| show_year |
| 3 | show_imdb |
| 4 | show_posterart_location—e.g., a URL. |
| 5 | show_description |
| 6 | show_serviceA . . . F—could be one or many. Display |
| | what is available for the row. |

According to embodiments, the social network-based content curation system can generate interfaces including other features, such as, for example, the information or display elements identified in the following table:

| Element | |
|---|---|
| on Screen | Description |
| A | Play Trailer: for this sprint, display the play trailer |
| | button but make it inactive. |
| B | Recommend/Do not recommend icon: for this sprint, |
| | display but make inactive. |
| C | Watchlist icon: display and support functionality |
| | (section below) |
| D | Comment icon: display, make inactive |
| E | Friends: for this sprint, display three placeholder |
| | thumbnails overlapping as illustrated, with the |
| | caption “Three friends are watching” beneath. |
| | This function will be inactive for now. |
| F | Back: functional, returns to list of shows |

According to embodiments, the social network-based content curation system executes watchlist interaction functionality which enables the management of a watchlist by a target user. In an embodiment, the social network-based content curation system provides for the ability to add a show to the watchlist in one of the following exemplary states: 1) Want to watch; 2) Watching; and 3) Watched.

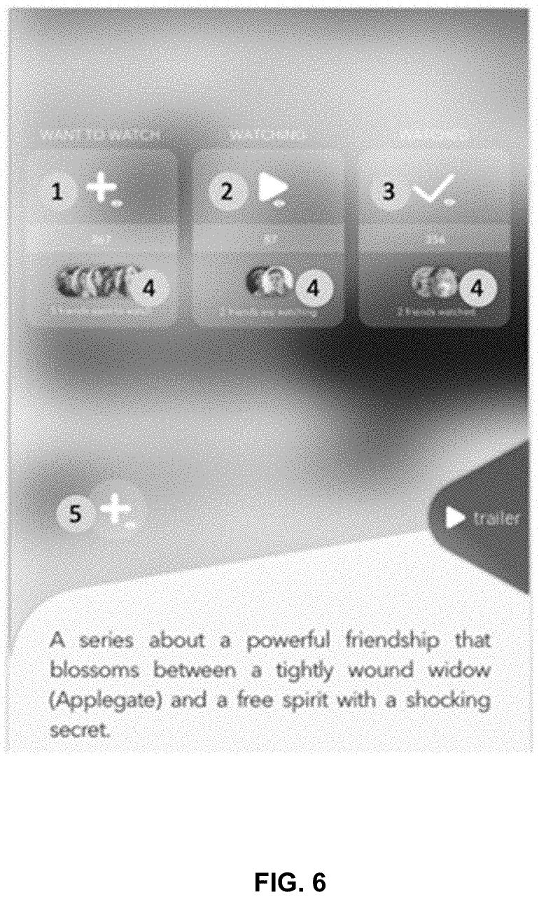

In an embodiment, with reference to FIG. 6, the watchlist icon, when clicked, presents a user interface that takes over the poster art section of the screen, blurs the poster art into the background, and allows the target user to take the secondary action of marking the show one of the example above.

In an embodiment, the social network-based content curation system is configured to generate an interface, such as the example interface of FIG. 6, including one or more of the example interface elements identified in FIG. 6 and the following table:

| Element | |
|---|---|
| on screen | Description |
| 1 | Tapping here marks the show as “Want to watch” |
| 2 | Tapping here marks the show as “Watching” |
| 3 | Tapping here marks the show as “Watched” |
| 4 | This shows friends in your network who have marked this |
| | show in this state. For now, simply display 3 static thumb- |
| | nails with the labels “3 friends want to watch,” “3 friends |
| | are watching,” and “3 friends watched” respectively. |
| 5 | Tapping the icon again closes the interaction. Once closed, |
| | the eye icon should display the marker to show its state |
| | (a + for want to watch, a triangle for watching, and a |
| | check for watched). |

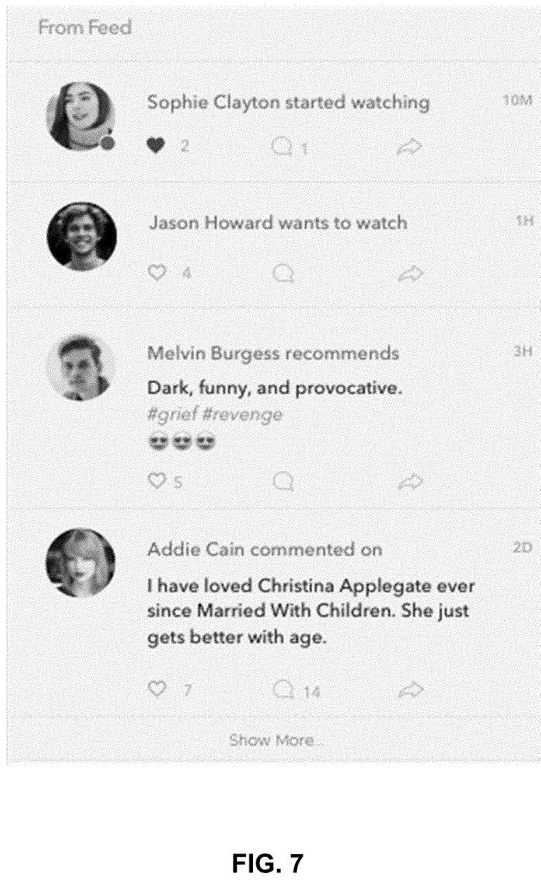

According to embodiments, the social network-based content curation system can generate an interface relating to an example content-specific feed (e.g., a show-specific feed), such as the interface shown in FIG. 7. In an embodiment, the content-specific feed can be displayed in as static text.

In an embodiment, the social network-based content curation system can provision information relating to a cast associated with content. In an embodiment, a file may be maintained (e.g., an Excel file) including character and case information, such as, for example, show_actorX_name→the name of the actor (e.g. Christina Applegate); show_actorX_character→the name of the actor's character (e.g. Jen Harding); show_actorX_image→the URL location of the thumbnail to use for the actor, etc.

In an embodiment, the social network-based content curation system enables interaction with actor related links, such as a micro-interaction including a horizontally scrollable interface with movement or scrolling across a set of multiple thumbnails or other icons.

In an embodiment, the social network-based content curation system can generate one or more interfaces relating to content (e.g., a TV show) that has one or many seasons, and each season can have a varied number of episodes. In an embodiment, a detail page can be generated a “show” level. In an embodiment, a season selector icon can be provided that allows a target user to switch between seasons. In an embodiment, if the content is associated with multiple seasons or parts, the social network-based content curation system can generate an initial or default interface displaying information relating to season 1.

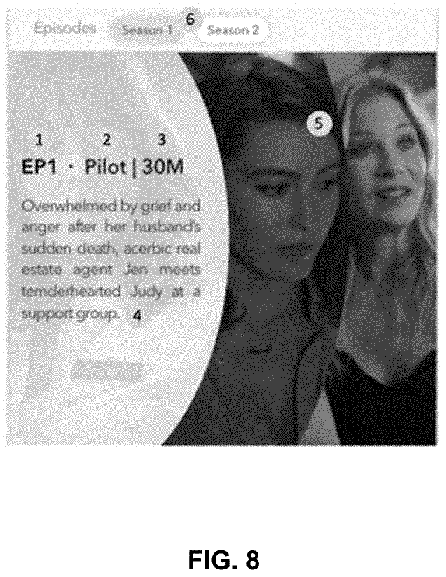

In an embodiment, the social network-based content curation system is configured to generate one or more interfaces relating to content having multiple episodes, parts, or portions. In an embodiment, the episode-related interfaces can include information such as the example information shown in FIG. 8 and described in the following table:

| Element | |
|---|---|
| on screen | Description |
| 1 | episode_number |
| 2 | episode_title |
| 3 | show_length (take from Shows sheet, use the same |
| | length for each episode in the show) |
| 4 | episode_description |
| 5 | episode_image |
| 6 | show season: Season to which the episode belongs |

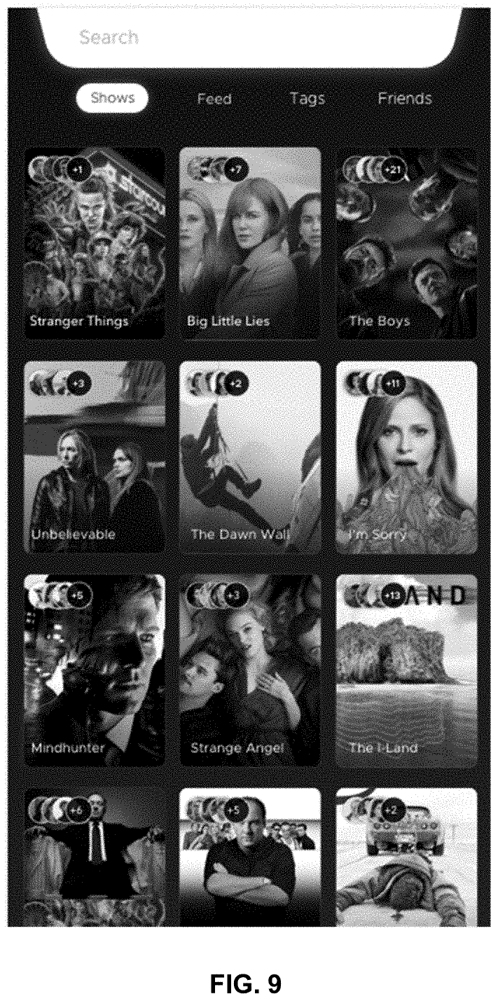

In an embodiment, the social network-based content curation system generates one or more interfaces including information relating to available content (e.g., shows). In an embodiment, the content can be presented in a grid-type arrangement displayed via a single screen or interface using, for example poster art, such as the example interface shown in FIG. 9. In an embodiment, this interface view can generated based on metadata including, for example, a show_title and a show_posterart_location (e.g., a file location associated with the poster art relating to the content). In an embodiment, interacting with the icon (e.g., tapping, clicking, etc.) associated with particular content can provide a corresponding detail page associated with that content.

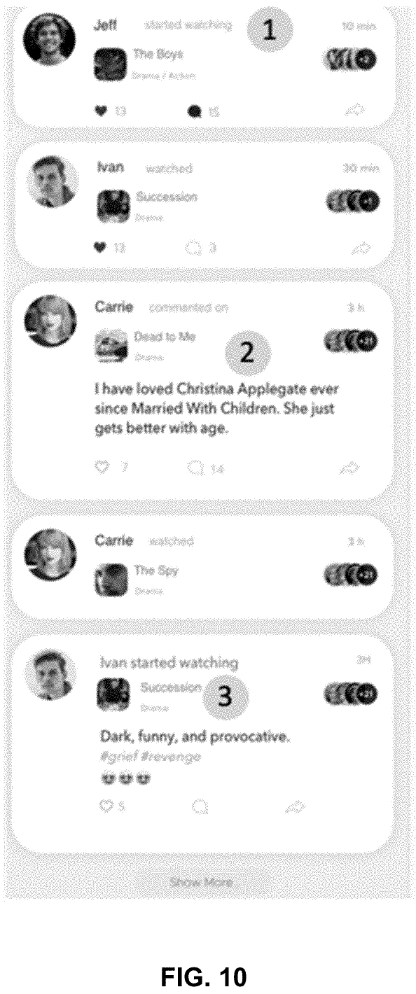

In an embodiment, the social network-based content curation system generates a social network-based feed associated with a target user, such as the example shown in FIG. 10. In an embodiment, the social network-based feed is customized and personalized for each target user based on that user's identified social network of friends or other users. In an embodiment, the feed can include one or more actions, indicators, or functions that can be executed, such as, for example: add a show to “want to watch” {username} wants to watch {show_title}, add a show to “watching” {username} started watching {show_title}; and add a show to “watched” {username} watched {show_title}. In an embodiment, a date/time stamp can be associated with the respective action (e.g., to identify the minutes/hours/days ago from the current time that the action took place).

In an embodiment, the example feed of FIG. 10 can include one or more of the following example elements, as set forth in the following table:

| Element | |
|---|---|
| on Screen | Description |
| 1 | Example of activity output. User (Jeff) started watching |
| | show title (The Boys) 10 minutes ago |
| 2 | Example of static comment interspersed with activity |
| | data. Copy to be provided. |
| 3 | Clicking on show title or thumbnail generates detail page |

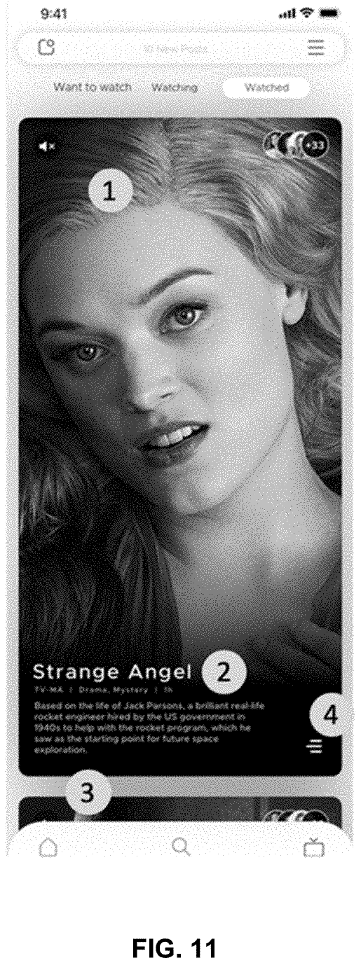

In an embodiment, as described above, the social network-based content curation system can generate interfaces associated with multiple different modes or states of a watchlist including filtered content based on the particular filter state, such as, including a “want to watch” filter state, a “watching” filter state, and a “want to watch” filter state. In an embodiment, the want to watch filter state identifies and tracks a list of content (e.g., shows and movies) marked by a user system as content the user system would like to watch, based on recommendations from the user system's social network (e.g., group of friends) feeds, or suggestions identified via a search. In an embodiment, the user system can navigate to the “want to watch” interface when selecting new content to consume, thereby enabling the efficient and quick identification and consumption of content. FIG. 11 illustrates an example interface associated with the “want to watch” filter mode. As shown in FIG. 11, the interface can include one or more of the example elements as set forth in the following table:

| Element | |
|---|---|
| on Screen | Description |
| 1 | Poster Art |
| 2 | Metadata: Show name, e.g., 3 lines of description, |
| | Rating \| Genre \| Length |
| 3 | Hint of next show in the list |
| 4 | Ellipsis opens the menu of actions (see next section) |

In an embodiment, the interface of FIG. 11 can be generated as a full screen to enable browsing through content and enable a user system to make a content selection. In an embodiment, the poster art can cover a majority of the interface, with a hint of other content displayed above a bottom navigational portion to indicate a “swiping up” interaction can be used to browse through additional content (e.g., the want to watch list of content). In an embodiment, when a last content item on the list is reached, the downward scrolling or carousel functionality terminates and further user action enables a scrolling back up through the list. In an embodiment, the social network-based content curation system can maintain or preserve a location within the scrollable interface including the list such that if the user system leaves or exits the screen, the user may return to that preserved location. In an embodiment, the location may no longer preserved if the user ends the current session.

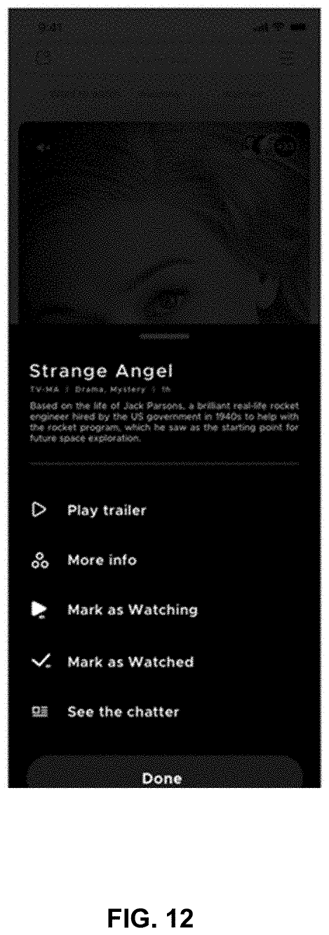

In an embodiment, interaction with a portion of the interface (e.g., the ellipsis of element 4 in FIG. 11) can cause the system to generate an interface including additional information about the related content (e.g., a content description, such as the example shown in FIG. 12). As shown in the example interface of FIG. 12, one or more menu items or elements may be displayed, including, for example, a “play trailer” feature configured to open a trailer via link to a browser window, a “more info” feature configured to open a detail view for this selected content, a “mark as watching” feature configured to transition the selected content to a “watching” filter state, display a check mark or other indicator to indicate a successful transition to the “watching filter state, closes the current menu, removes the selected content from the “want to watch” filter state, and causes a next content item in the queue to move up in positional location to replace it the transitioned content item). In an embodiment, as shown in FIG. 8, the menu can include a “mark as watched” feature configured to transition the selected content to a “watched” filter state, display a check mark or other indicator to indicate successful transition to the “watched” filter state, closes the menu, and removes the selected content from the “want to watch” listing, with the next content item in the queue moving up in positional location to replace the transitioned content item. In an embodiment, the menu can include a “see the chatter” link which is associated with a feed of comments relating to the selected content from the social network of the user system.

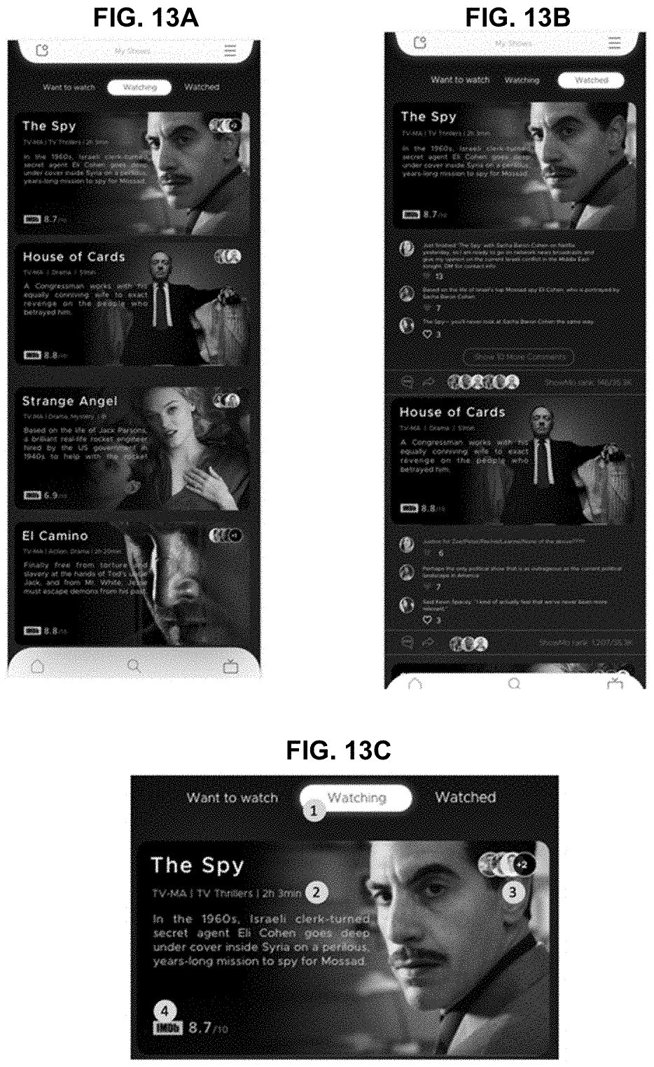

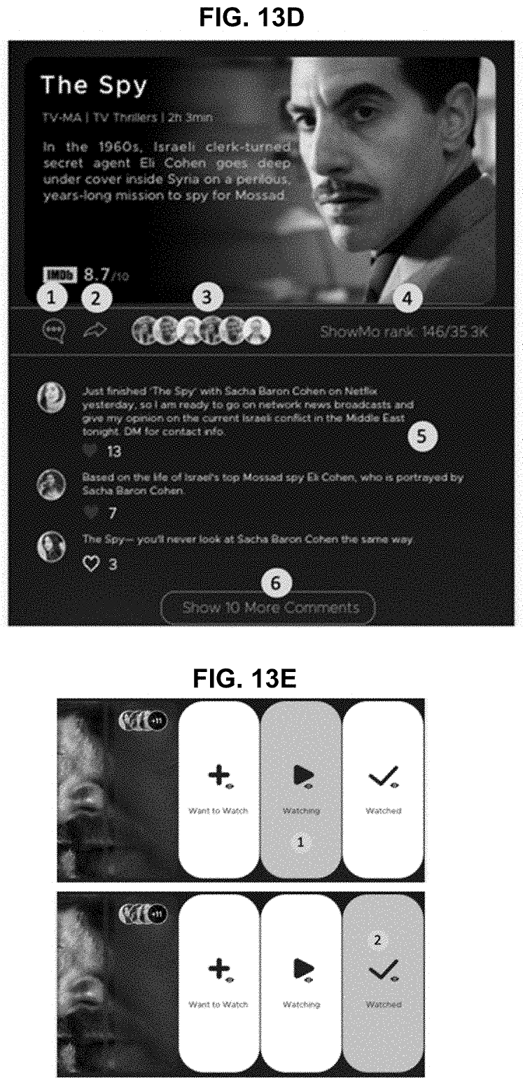

FIGS. 13A-13C illustrate example interfaces associated with the “watching” filter state, according to embodiments of the present disclosure. In an embodiment, the interfaces of the watching filter state include a listing of content the user system is currently watching. In an embodiment, the list of content can be generated based on an integration with one or more content delivery services (e.g., Netflix, Hulu, Amazon Prime Video, etc.)

As shown in FIG. 13C, the watching interface can include one or more example elements, including the elements described in the following table:

| Element | |
|---|---|
| on Screen | Description |
| 1 | Filters: users can tap each of these filters to change |
| | the state of the screen. |
| 2 | Content metadata: e.g., metadata pulled from a |
| | corresponding file (e.g., an Excel file) including |
| | text for the content description. |
| 3 | Friends: for this sprint, display placeholder |
| | thumbnails overlapping as illustrated. |
| 4 | A rating from metadata (e.g., an IMDB rating) |

FIG. 13D illustrates an example expanded view relating to FIGS. 9A-9C, according to an embodiment. As shown, the interface of FIG. 13D includes feed activity filtered to the selected content item (e.g., comments from the user system's social network integrated with and relating to this particular content item). In an embodiment, a first set of entries (e.g., four entries are displayed), followed by a “Show x More Comments” link. In an embodiment, the example interface of FIG. 13D including one or more of the following example elements as described in the following table:

| Element | |
|---|---|
| on Screen | Description |
| 1 | Ability to add a comment. Optionally advances |
| | to comment pane. |
| 2 | Share—display icon, but inactive |
| 3 | Friends: expanded list of thumbnails of friends |
| | engaged in this show. |
| 4 | Rank: display static text: e.g., rank: 146/35.1K |
| 5 | For example, a first set of four comments are |
| | displayed |
| 6 | Show x More comments where x equals |
| | number of comments not displayed. Show x |
| | More Comments button opens a new window |
| | with the same screen orientation and all available |
| | comments in a scrollable view. From that screen, |
| | users can submit new comments and reply to |
| | existing comments as well. In an embodiment, |
| | if the comment icon on expanded view is tapped, |
| | therefore, it behaves the same, by going to that |
| | screen, where the comment entry fields can |
| | be above the footer. |

FIG. 13E illustrates an example interface relating to the “watching” interfaces of FIGS. 13A-13D, according to embodiments. As shown in FIG. 13E, a swiping action enables the user system to change the state associated with the content item. For example, FIG. 13E can include example elements in the interface, such as the elements identified in the following table:

| Element | |
|---|---|
| on Screen | Description |
| 1 | The current selected state is displayed with the |
| | grey background |
| 2 | Tapping any other state changes the background |
| | and dismisses the swipe |

According to embodiments, when the content item is transitioned out of a state, the content item can be removed from the filtered list the user is in. In an embodiment, the remaining portion of the list can shift upwards. In an embodiment, the action that is taken is output to the feed, such as, for example, “Carrie watched The Spy”, “Carrie is watching The Spy”, or “Carrie wants to watch The Spy”. In an embodiment, another action (e.g., a swiping action) with respect to FIGS. 13A-13E can cause the social network-based content curation system to remove the content item from the list.

In an embodiment, as described above, the social network-based content curation system can generate interfaces relating to a list of “watched” content items. In an embodiment, the “watched” filter state includes a list of content items the user has completed watching. In an embodiment, the “watched” filter state can include interfaces that look and function the same as the “watching” view, with the exception that the filter is set to “watched”.

In an embodiment, the social network-based content curation system can use the watchlist (e.g., in the one or more filter states described above) to generate a feed including information relating to a user system's activity and the activity of the user system's social network. In an embodiment, when a user adds a content item to the watchlist or makes a comment on a content item, the social network-based content curation system generates a post for the corresponding feed. In an embodiment, each post has its own card. In an embodiment, other users may then add comments and replies to a post.

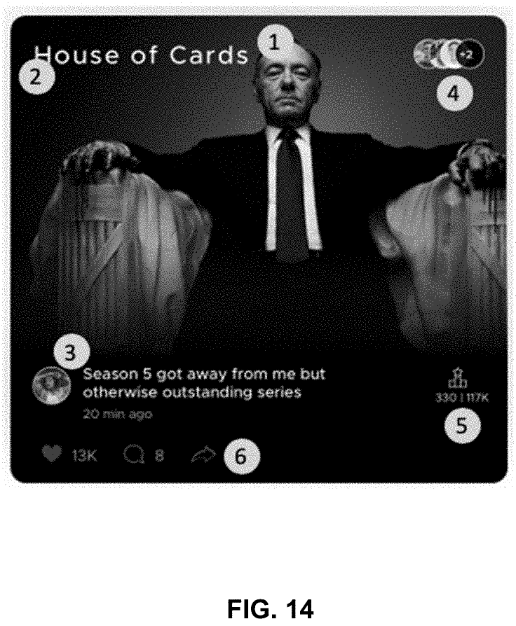

FIG. 14 illustrates an example card according to embodiments of the present disclosure. In an embodiment, the cards can be generated and presented in a similar manner as the watchlist described above, with an indication of the selected metadata such as the content title (e.g., element 1 of FIG. 14). In an embodiment, as shown in FIG. 14, element 2 can include a status of the user with respect to the content (e.g., watching, want to watch, etc.). In an embodiment, such as the example shown in FIG. 14, if the user system does not have a status for the particular content, then no icon or indicator is displayed.

In an embodiment, element 3 of FIG. 14 includes a post (e.g., either a comment, an action, or both) is displayed, with an avatar or other icon associated with the source of the post and an indicator of the time elapsed since the posting of the comment. In an embodiment, if the post includes an action, an indicator of the action may be displayed (e.g., “Jeff wants to watch,” “Jeff is watching,” or “Jeff recommends”). In an embodiment, if the post includes a comment, the avatar and a first portion of the lines of the comment (e.g., the first four lines of the comment) are displayed, with an ellipsis, if necessary. In an embodiment, in the case of a comment only, prior to the time elapsed, the user's name (e.g., Jeff 10m) can be displayed to account for the fact that there is no action and therefore no name otherwise.

In an embodiment, element 4 of FIG. 14 includes a set of one or more thumbnail avatars (e.g., on the upper right of the interface) displaying friends in the user system's network who are engaging with this show (e.g., either Want to watch, Watching, or Recommended). In an embodiment, element 5 of FIG. 14 can include a badge icon showing a rank for the content item. For example, a ranking (e.g., a number) displays the show's overall ranking across the network, based on, for example, a total number of people across the network who have watched and/or recommended the show.

In an embodiment, element 6 of FIG. 14 includes an icon bar including icons to enable the user system to perform actions including, but not limited to, liking the post, adding a comment/reply, or sharing the post outside the network (e.g., to another social media network, via text, via e-mail, etc.).

In an embodiment, the interface of FIG. 14 can include swipe functionality to enable a swipe action to add or change state (e.g., add to a watchlist, remove from the watchlist, etc.)

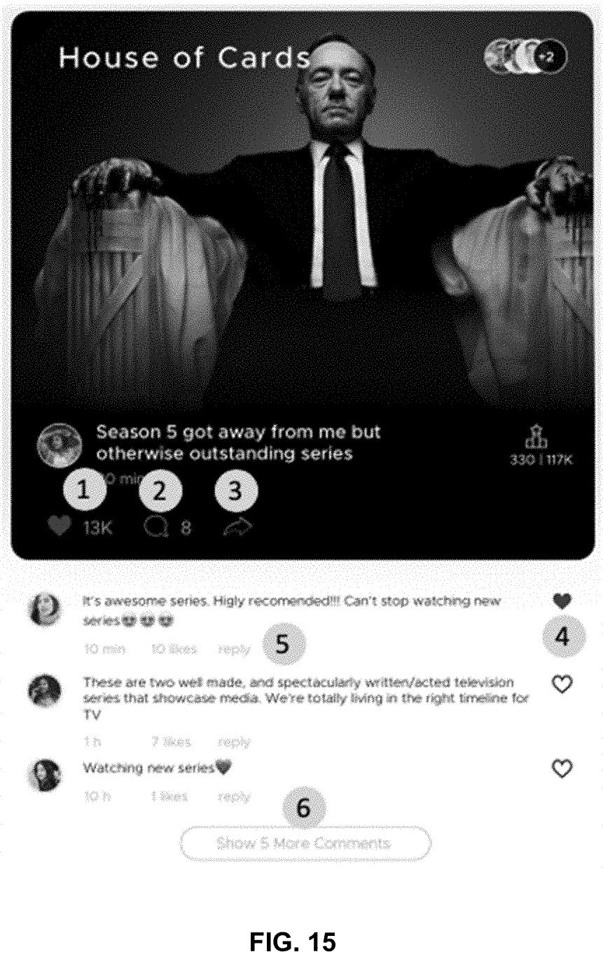

FIG. 15 illustrates an example card in an expanded view, according to embodiments of the present disclosure. As shown, element 1 of FIG. 15 includes a heart icon that can be interacted with to indicate a “like” sentiment. In an embodiment, the user system can input an action (e.g., tapping the heart icon) to indicate a “like” for the post, where the number underneath shows the total number of likes this post has received. In an embodiment, the user system can tap the heart icon again to unlike. In an embodiment, element 2 of FIG. 15 includes an icon to enable the user system to add a comment (e.g., by tapping the comment icon to add a comment to the post), where the number underneath shows the total number of comments and replies this post has received.

In an embodiment, element 3 of FIG. 15 includes an icon to enable the user system to share the post (e.g., by tapping the share icon to share outside of the social network-based content curation system). In an embodiment, element 4 of FIG. 15 includes a portion of the interface displaying recent comments relating to the content item (e.g., listing of the three most recent comments are displayed), where each comment can be displayed with a number of likes that comment has received. The user also has the ability to tap the heart to like a comment, which changes the icon to full red and increases the count.

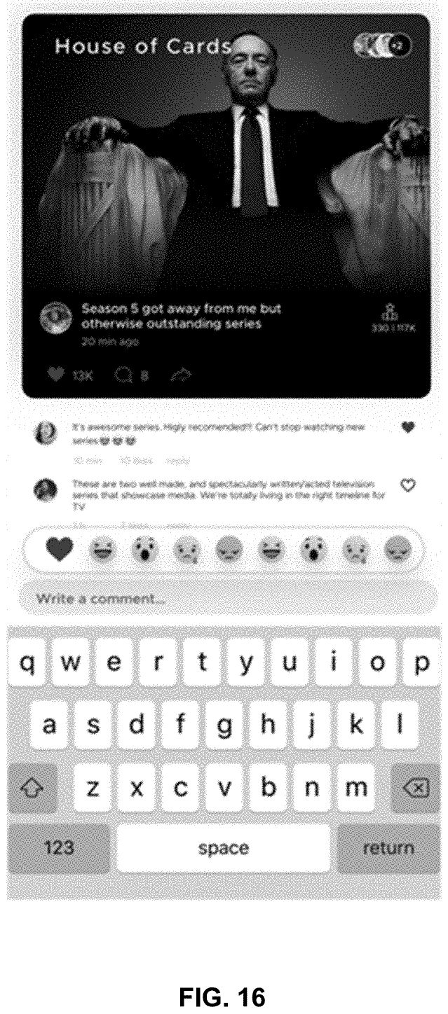

In an embodiment, element 5 of FIG. 15 includes an icon to enable the user system to reply to a comment. Interaction with element 5 navigates the user system to a comments interface (as shown in FIG. 16), scrolled to a corresponding or correct location. In an embodiment, element 6 of FIG. 15 includes an icon to enable the user system to show x more comments—the total number of comments minus 3 is displayed for x, so in this case 5 of 8. Interaction with element 6 can navigate the user system to the comments interface, as shown in FIG. 16.

FIG. 16 illustrates a comments interface generated by the social network-based content curation system, according to embodiments of the present disclosure. In an embodiment, a comment can be added by the user system in the view shown in FIG. 16 by tapping the comment icon or the reply link under each comment visible in this view to generate a keyboard and commenting functionality. In an embodiment, once the user system types and posts the comment, the comment is added to expanded view. The comments can be displayed newest to oldest in this view, and oldest to newest in the comments view (e.g., the added comment can appear at the top and pushes the oldest comment out of the viewable display). In an embodiment, if the user system is typing a reply, the reply can be shown threaded below the original comment and no other comment may be pushed out of sight.

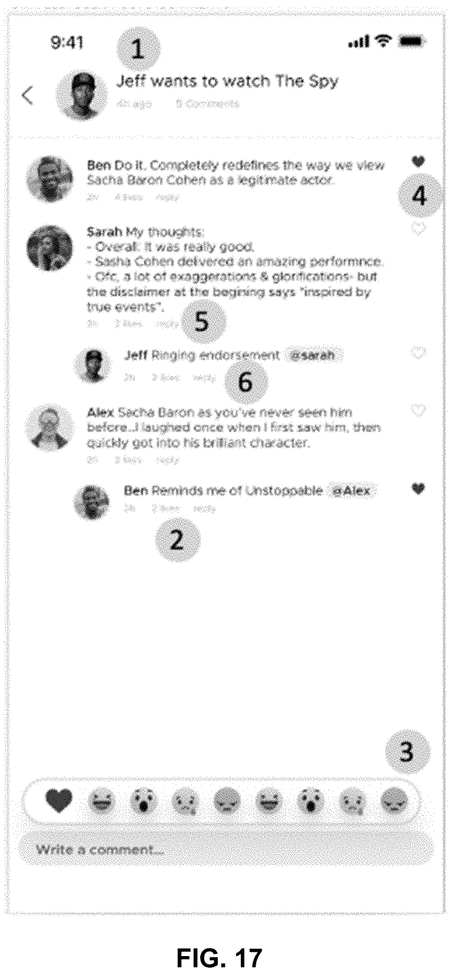

FIG. 17 illustrates an expanded comments interface generated by the social network-based content curation system, according to embodiments of the present disclosure. As shown in FIG. 17, element 1 displays a comment or action with the original post, along with the user's avatar and the time lapse or date/time, which can be separated from the rest of the comments with a thin horizontal rule. In an embodiment, the user system can tap the back icon to return to the main screen. Element 2 of FIG. 17 includes a chronologically ordered listing of comments from least recent to most recent, and the user system is actively scrolled to the bottom of the screen so the most recent comment is displayed. In an embodiment, if the user system tapped reply from the expanded view, the interface is scrolled to the location of the comment to which they are replying. Element 3 of FIG. 17 includes a comment field and common emojis, where the keyboard can be hidden until the user system taps in the “Write a comment” field. The emojis can behave as in-message emojis (e.g., not reactions). Tapping the emoji can cause insertion of the emoji into the message. In an embodiment, access to other emojis can be enabled via a keyboard of a device of the user system.

In an embodiment, element 4 of FIG. 17 includes an icon for interaction by the user system (e.g., a tap action) to like a comment. Element 5 can include information under each comment that identifies a time lapse, a number of likes, a reply link, etc. In an embodiment, interaction with element 6 of FIG. 17 enables the sending of a reply in which the user system can type a comment below the original comment and indented. In an embodiment, while a reply can be tapped below that thread, one level of indentation is displayed in the interface of FIG. 17. Second or later level threading can include the name of the user to which the commenter is replying prior to their comment (e.g., @jeff this is a great show).

In an embodiment, a “recommend” filter state can be employed. In this embodiment, the three filter states can include a “want to watch” filter state, a “watching” filter state, and a “recommend” filter state. In an embodiment, the “recommend” filter state can identify one or more content items that the user system is recommending to his or her social network of friends within the social network-based content curation system.

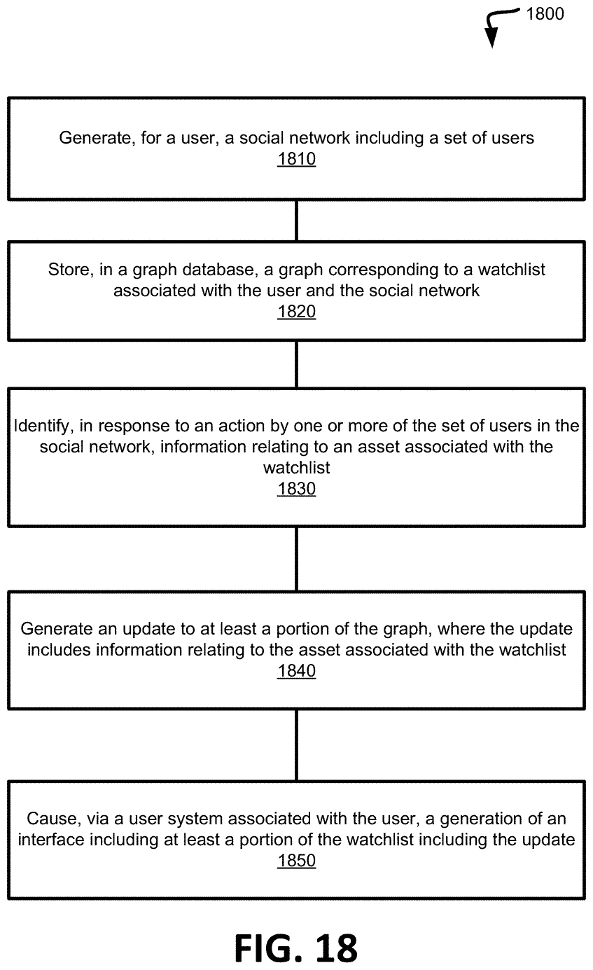

FIG. 18 of an example method 1800 to manage social network-based content curation relating to one or more assets, in accordance with some embodiments of the disclosure. The method 1800 can be performed by processing device that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 1800 is performed by the social network-based content curation system 100, 200, 300, 400 of FIGS. 1, 2, 3, and 4, respectively. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 1810, the processing logic (e.g., processing logic of social network-based content curation system 100, 200, 300, and/or 400) generates, for a user, a social network including a set of users. In an embodiment, each user (e.g., user 1) can identify one or more other user systems (e.g., user 2, user 3, user 4, etc.) that are associated with the social network-based content curation system. For example, the social network-based content curation system can maintain accounts, profiles, etc. associated with a number of different users. Each user can, via the social network-based content curation system, establish a corresponding social network (e.g., by selecting one or more other users (e.g., “friends”) including a set of users.

At operation 1820, the processing logic stores, in a graph database, a graph corresponding to a watchlist associated with the user and the social network. In an embodiment, the graph database can include a graph corresponding to each of the users. The graph can include a set of nodes and relationships defining a data structure representing a watchlist of the user and information relating to the user's social network. In an embodiment, the watchlist can include information relating to one or more consumable assets (e.g., TV shows, movies, limited series, etc.). The watchlist of a user can include the list of assets that are curated based on information associated with the user's social network.

At operation 1830, the processing logic identifies, in response to an action by one or more of the set of users in the social network, information relating to an asset associated with the watchlist. In an embodiment, the information can include metadata associated with the asset (e.g., metadata collected from one or more metadata sources), a rating associated with the asset, a comment associated with the asset, a review associated with the asset, an indication associated with the asset, a recommendation associated with the asset, etc. In an embodiment, the information relating to the asset can be captured in response to an action executed by a user in the social network via one or more interfaces of the social network-based content curation system.

At operation 1840, the processing logic generates an update to at least a portion of the graph, where the update includes information relating to the asset associated with the watchlist. In an embodiment, having identified the update to the watchlist in view of the action by a member of the user's social network, the processing logic updates the user's graph in the graph database. In an embodiment, the watchlist represented by the graph of the user is updated to include the update including the information associated with the asset (e.g., a comment about the asset, a recommendation relating to the asset, an indication relating to the asset, etc.). For example, if the update includes a post associated with a first asset (e.g., a TV show) from a first friend in the social network, the watchlist for the user is updated to include the post information.

At operation 1850, the processing logic causes, via a user system associated with the user, a generation of an interface including at least a portion of the watchlist including the update. In an embodiment, the user system can be any device (e.g., a mobile device, a television, etc.) that is associated with the user. In an embodiment, the user system can be associated with the user by way of a login procedure using an application corresponding to the social network-based content curation system (e.g., a mobile application installed on a mobile device or an on-screen application associated with a television-related device such as a smart TV, IoT device, etc.).

In an embodiment, the interface associated with the application can include at least a portion of the watchlist including the update. For example, the interface can display the asset and the corresponding update to enable the provisioning of the social network-based information concerning the asset to be displayed to the user.

According to embodiments, further features and functions associated with managing a social network-based watchlist on behalf of a user can be executed in connection with the process 1800, as described in detail above. For example, in an embodiment, the update can include the addition of an asset (e.g., a TV show, a movie, etc.) to the watchlist associated with the user. In response to the addition of the asset, a link can be established between the asset in the graph of the user stored in the graph database and a metadata repository to enable the provisioning of updated information relating to the asset via the user's watchlist.

In an embodiment, the watchlist can be checked or reviewed by the user via one or more interfaces of an application associated with the social network-based content curation system (e.g., a mobile application or an on-screen application). In an embodiment, the user can view the updated watchlist including a listing of assets and related information (e.g., posts relating to the one or more assets, comments relating to the one or more assets, metadata associated with the one or more assets, etc.

In an embodiment, the assets included within the watchlist can be ranked or ordered in accordance with one or more heuristics. In an embodiment, the user can interact with an asset listed in the watchlist to enable the selection of the asset for viewing. In an embodiment, in response to the interaction with the asset via the watchlist, a corresponding content provider service (e.g., Netflix, Hulu, Disney Plus, etc.) can be launched via the user system. The content provider service can be directed to a location associated with the selected asset, to enable the user to interact with the asset in the content provider service (e.g., play the selected asset, review data associated with the data, etc.).

According to embodiments, the user-personalized watchlist (e.g., a listing of assets) and actions relating to the watchlist (e.g., comments, posts, recommendations, etc.) can be arranged in a feed configuration (e.g., in a newsfeed-type arrangement) for display via an interface of a user system. In an embodiment, the user-personalized feed includes an ordered listing of the watchlist and actions and activities of the members of the user's social network.

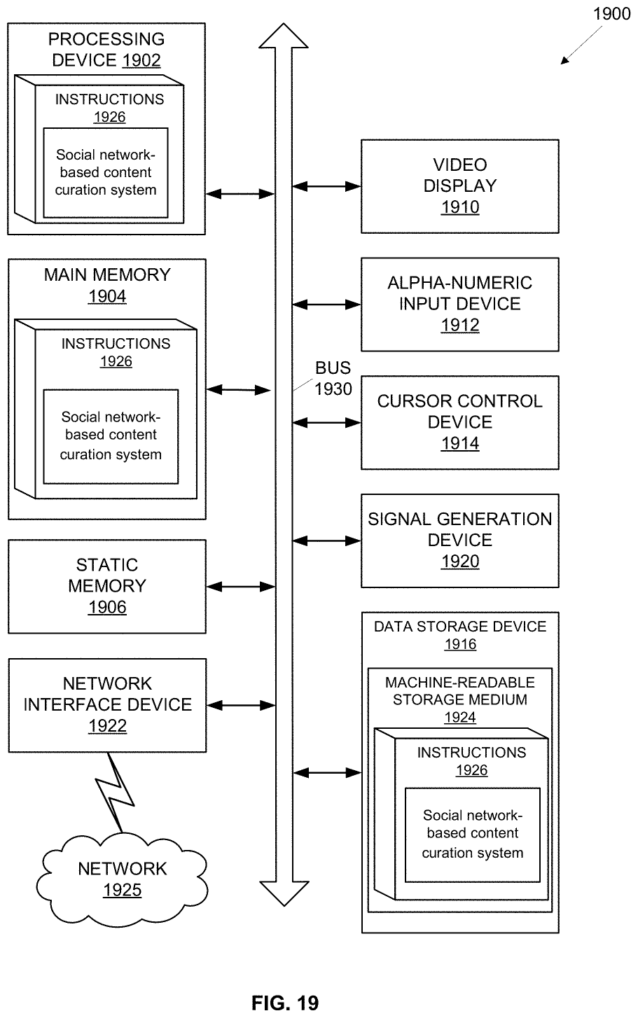

FIG. 19 illustrates an example computer system 1900 operating in accordance with some embodiments of the disclosure. In FIG. 19, a diagrammatic representation of a machine is shown in the exemplary form of the computer system 1900 within which a set of instructions, for causing the machine to perform any one or more of the methodologies discussed herein, may be executed. In alternative embodiments, the machine 1900 may be connected (e.g., networked) to other machines in a local area network (LAN), an intranet, an extranet, or the Internet. The machine 1900 may operate in the capacity of a server or a client machine in a client-server network environment, or as a peer machine in a peer-to-peer (or distributed) network environment. The machine may be a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that machine 1900. Further, while only a single machine is illustrated, the term “machine” shall also be taken to include any collection of machines that individually or jointly execute a set (or multiple sets) of instructions to perform any one or more of the methodologies discussed herein.

The example computer system 1900 may comprise a processing device 1902 (also referred to as a processor or CPU), a main memory 1904 (e.g., read-only memory (ROM), flash memory, dynamic random access memory (DRAM) such as synchronous DRAM (SDRAM), etc.), a static memory 1906 (e.g., flash memory, static random access memory (SRAM), etc.), and a secondary memory (e.g., a data storage device 1916), which may communicate with each other via a bus 1930.

Processing device 1902 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1902 may also be one or more special-purpose processing devices such as an application specific integrated circuit (ASIC), a field programmable gate array (FPGA), a digital signal processor (DSP), network processor, or the like. Processing device 1902 is configured to execute a social network-based content curation system for performing the operations and steps discussed herein. For example, the processing device 1902 may be configured to execute instructions implementing the processes and methods described herein, for supporting a social network-based content curation system, in accordance with one or more aspects of the disclosure.

Example computer system 1900 may further comprise a network interface device 1922 that may be communicatively coupled to a network 1925. Example computer system 1900 may further comprise a video display 1910 (e.g., a liquid crystal display (LCD), a touch screen, or a cathode ray tube (CRT)), an alphanumeric input device 1912 (e.g., a keyboard), a cursor control device 1914 (e.g., a mouse), and an acoustic signal generation device 1920 (e.g., a speaker).

Data storage device 1916 may include a computer-readable storage medium (or more specifically a non-transitory computer-readable storage medium) 1924 on which is stored one or more sets of executable instructions 1926 of the social network-based content curation system. In accordance with one or more aspects of the disclosure, executable instructions 1926 may comprise executable instructions encoding various functions of the social network-based content curation system in accordance with one or more aspects of the disclosure.

Executable instructions 1926 may also reside, completely or at least partially, within main memory 1904 and/or within processing device 1902 during execution thereof by example computer system 1900, main memory 1904 and processing device 1902 also constituting computer-readable storage media. Executable instructions 1926 may further be transmitted or received over a network via network interface device 1922.

While computer-readable storage medium 1924 is shown as a single medium, the term “computer-readable storage medium” should be taken to include a single medium or multiple media. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “analyzing,” “selecting,” “receiving,” “presenting,” “generating,” “deriving,” “providing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the disclosure also relate to an apparatus for performing the methods described herein. This apparatus may be specially constructed for the required purposes, or it may be a general-purpose computer system selectively programmed by a computer program stored in the computer system. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear as set forth in the description below. In addition, the scope of the disclosure is not limited to any particular programming language. It will be appreciated that a variety of programming languages may be used to implement the teachings of the disclosure.

It is to be understood that the above description is intended to be illustrative, and not restrictive. Many other embodiment examples will be apparent to those of skill in the art upon reading and understanding the above description. Although the disclosure describes specific examples, it will be recognized that the systems and methods of the disclosure are not limited to the examples described herein, but may be practiced with modifications within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A method comprising:
generating, for a user, a social network comprising a set of users;
storing, by a processing device, in a graph database, a graph corresponding to the user, the social network, and a watchlist associated with the user;
identifying, in response to an action by one or more of the set of users in the social network, information relating to an asset associated with the watchlist;
generating an update to at least a portion of the graph, where the update includes information relating to the asset associated with the watchlist; and
causing, via a user system associated with the user, a generation of an interface comprising at least a portion of the watchlist comprising the update.

2. The method of claim 1, wherein the watchlist comprising an ordered listing of a plurality of assets and related information curated based at least in part on actions associated with the social network.

3. The method of claim 1, wherein the interface is presented via one or more of a mobile application executable by a first user device associated with the user or an on-screen application executable by a second user device associated with the user; and wherein the interface comprises a user-personalized feed comprising a least a portion of the watchlist and information relating to activities of the social network ordered in accordance with one or more heuristics.

4. The method of claim 1, further comprising collecting metadata associated with the asset from one or more metadata sources, wherein the update to the watchlist associated with the asset comprises the metadata.

5. The method of claim 1, wherein the information relating to the asset is displayed in connection with the asset via the watchlist.

6. The method of claim 1, wherein the information relating to the asset comprises at least one of a post from the social network associated with the asset, a comment from the social network associated with the asset, or an indication from the social network associated with the asset.

7. The method of claim 1, wherein the information further comprises a further update relating to the asset generated by the user via a first user device, and wherein the information is displayed at a subsequent time via the interface of a second user device.

8. A system comprising:
a graph database comprising a first graph corresponding to a first user;
a memory storing instructions; and
a processing device operatively coupled to the graph database and the memory, the processing device to execute the instructions to perform operations comprising:
generating, for the first user, a social network comprising a set of users;
storing, in the graph database, the first graph corresponding to a watchlist associated with the first user and the social network;
identifying, in response to an action by one or more of the set of users in the social network, information relating to an asset associated with the watchlist;
generating an update to at least a portion of the first graph, where the update includes information relating to the asset associated with the watchlist; and
causing, via a user system associated with the first user, a generation of an interface comprising at least a portion of the watchlist comprising the update.

9. The system of claim 8, wherein the watchlist comprises an ordered listing of a plurality of assets and related information curated based at least in part on actions associated with the social network.

10. The system of claim 8, wherein the interface is presented via one or more of a mobile application executable by a first user device associated with the first user or an on-screen application executable by a second user device associated with the first user.

11. The system of claim 8, the operations further comprising collecting metadata associated with the asset from one or more metadata sources, wherein the update to the watchlist associated with the asset comprises the metadata.

12. The system of claim 8, wherein the information relating to the asset is displayed in connection with the asset via the watchlist.

13. The system of claim 8, wherein the information relating to the asset comprises at least one of a post from the social network associated with the asset, a comment from the social network associated with the asset, or an indication from the social network associated with the asset.

14. The system of claim 8, wherein the information further comprises a further update relating to the asset generated by the user via a first user device, and wherein the information is displayed at a subsequent time via the interface of a second user device.

15. A non-transitory computer-readable medium comprising instructions, which when executed by a processing device, cause the processing device to perform operations comprising:
generating, for a user, a social network comprising a set of users;
storing, in a graph database, a graph corresponding to a watchlist associated with the user and the social network;
identifying, in response to an action by one or more of the set of users in the social network, information relating to an asset associated with the watchlist;
generating an update to at least a portion of the graph, where the update includes information relating to the asset associated with the watchlist; and
causing, via a user system associated with the user, a generation of an interface comprising at least a portion of the watchlist comprising the update.

16. The non-transitory computer-readable medium of claim 15, wherein the watchlist comprising an ordered listing of a plurality of assets and related information curated based at least in part on actions associated with the social network.

17. The non-transitory computer-readable medium of claim 15, wherein the interface is presented via one or more of a mobile application executable by a first user device associated with the user or an on-screen application executable by a second user device associated with the user.

18. The non-transitory computer-readable medium of claim 15, the operations further comprising collecting metadata associated with the asset from one or more metadata sources, wherein the update to the watchlist associated with the asset comprises the metadata.

19. The non-transitory computer-readable medium of claim 15, wherein the information relating to the asset comprises at least one of a post from the social network associated with the asset, a comment from the social network associated with the asset, or an indication from the social network associated with the asset.

20. The non-transitory computer-readable medium of claim 15, wherein the information further comprises a further update relating to the asset generated by the user via a first user device, and wherein the information is displayed at a subsequent time via the interface of a second user device.
